(19) United States
(12) Patent Application Publication
(10) Pub. No.: US 2026/0295314 A1
(43) Pub. Date: Oct. 1, 2026

(54) FIRE-RATED JOINT COMPONENT WITH MULTIPLE INTUMESCENT MATERIAL LAYERS AND RELATED WALL ASSEMBLIES

(71) Applicant: CEMCO, LLC, CITY OF INDUSTRY, CA (US)

(72) Inventors: Donald Anthony Pilz, Livermore, CA (US); David Mistler, City of Industry, CA (US)

(21) Appl. No.: 19/635,402

(22) Filed: Mar. 31, 2026

Related U.S. Application Data
(60) Provisional application No. 63/781,345, filed on Mar. 31, 2025.

(51) Int. Cl. A62C 2/06; E04B 1/94

(52) U.S. Cl. CPC A62C 2/065; E04B 1/948

(57) ABSTRACT

A fire-rated wall joint seal having a first intumescent layer and a second intumescent layer. The first intumescent layer has a length, a first side surface extending along the length, a second side surface extending along the length, and a thickness defined between the first side surface and the second side surface. The second intumescent layer has a length, a first side surface extending along the length, a second side surface extending along the length, and a thickness defined between the first side surface and the second side surface. The first intumescent layer and the second intumescent layer are formed separately and are attached to one another along their respective first side surfaces by an adhesive joint.

### PRIORITY AND INCORPORATION BY REFERENCE

This application claims the benefit of U.S. Provisional Application No. 63/781,345, entitled “TWO PLY INTUMESCENT FIRE BLOCK,” filed Mar. 31, 2025, pending, the entirety of which is incorporated by reference herein and made a part of the present disclosure. Any and all applications for which a foreign or domestic priority claim is identified in connection with the present application are hereby incorporated by reference herein and made a part of the present disclosure.

### BACKGROUND

### Field

The present disclosure generally relates to fire-rated building structures, which can include fire-rated joint seal components. In particular, the present disclosure relates to fire-rated joint systems, wall assemblies, and other building structures that incorporate fire-rated joint seal components. In some configurations, the fire-rated joint seal components may be configured to allow for relatively large deflection gaps.

### Description of Related Art

With the rise in data center construction in the United States and elsewhere, the need for large deflection fire-rated joints, e.g., with 2” to 6” movement, has dramatically increased. Prior to the influx of data center construction, the average width for fire-rated joints was generally between 1/2” to 1-1/2”.

With data centers, the dynamic movement requirement for fire-rated joints can start at 2” and goes as high as 6”. As used herein, movement of a fire-rated joint refers to relative movement between two portions of a wall. Typically, the wall is a metal stud wall having a frame, which includes a footer track, a header track, and a plurality of studs extending between the footer track and the header track. The wall also includes one or more wallboards on one or both sides of the wall attached to the frame. Often, movement occurs between one of the tracks (e.g., a header track) attached to one support structure (e.g., an overhead structure, such as a ceiling or floor of the above story in a multi-story building) and another portion of the wall (e.g., the footer track, studs, and wall board). However, the dynamic joint can be located between any two portions of any type of wall assembly.

Various manufacturers were able to provide a fire-rated joint up to 1-1/2” dynamic movement. However, the wider joints created a problem with passing the UL 2079 fire test for building joints using existing fire-rated joint products and assemblies.

### SUMMARY

The present disclosure relates to a fire-rated wall joint seal having at least two layers of intumescent material. The present inventor unexpectedly discovered that an intumescent strip having two separate layers of intumescent material performs better in a fire test than a single-layer intumescent strip of equal thickness. The fire-rated wall joint seals disclosed herein include at least two layers of intumescent material and can include more than two layers, such as three, four, five, or six layers of intumescent material, for example. The example applications for the multi-layer intumescent material joint seals described herein relate to wall joints, especially those in which the seal is positioned between the wall framing and the wallboard. In such an application, the maximum thickness of the seal has a practical limit, which may place a practical limit on the number of layers of intumescent strips provided in the seal. However, in other applications, the number of strips may not be so limited.

The systems, methods and devices described herein have innovative aspects, no single one of which is indispensable or solely responsible for their desirable attributes. Without limiting the scope of the claims, some of the advantageous features will now be summarized.

An aspect of the present disclosure involves a fire-rated wall joint seal, having a first intumescent layer and a second intumescent layer attached to one another. The first intumescent layer is configured to expand at a lower temperature or at an earlier stage of fire exposure than the second intumescent layer. The expansion of the first intumescent layer displaces the second intumescent layer away from a heat source and forms a thermally insulating barrier that delays expansion and degradation of the second intumescent layer.

In some arrangements, the first intumescent layer is configured to function as a sacrificial layer that undergoes substantial expansion and structural degradation prior to expansion of the second intumescent layer.

In some arrangements, expansion of the first intumescent layer increases the distance between the second intumescent layer and the heat source during fire exposure.

In some arrangements, the sacrificial expansion of the first intumescent layer reduces heat transfer to the second intumescent layer.

In some arrangements, the first intumescent layer forms an expanded char layer that acts as a thermal barrier protecting the second intumescent layer.

In some arrangements, the second intumescent layer maintains structural integrity for a longer duration than the first intumescent layer during fire exposure.

In some arrangements, the second intumescent layer limits the passage of hot gases through the joint after expansion of the first intumescent layer.

In some arrangements, the first intumescent layer and the second intumescent layer are configured to expand sequentially rather than simultaneously.

In some arrangements, the first intumescent layer reaches maximum expansion prior to initiation of expansion of the second intumescent layer.

An aspect of the present disclosure involves a fire-rated wall joint seal, having a first intumescent layer and a second intumescent layer. The first intumescent layer has a length, a first side surface extending along the length, a second side surface extending along the length, and a thickness defined between the first side surface and the second side surface. The second intumescent layer has a length, a first side surface extending along the length, a second side surface extending along the length, and a thickness defined between the first side surface and the second side surface. The first intumescent layer and the second intumescent layer are formed separately and are attached to one another along their respective first side surfaces by an adhesive joint.

In some arrangements, a combined thickness of the first intumescent layer and the second intumescent layer is equal to or greater than 80 percent of a total thickness of the fire-rated wall joint seal.

In some arrangements, a combined thickness of the first intumescent layer and the second intumescent layer is equal to or greater than 90 percent of a total thickness of the fire-rated wall joint seal.

In some arrangements, a combined thickness of the first intumescent layer and the second intumescent layer is equal to or greater than 95 percent of a total thickness of the fire-rated wall joint seal.

In some arrangements, a combined thickness of the first intumescent layer and the second intumescent layer is equal to or greater than 98 percent of a total thickness of the fire-rated wall joint seal.

In some arrangements, a combined thickness of the first intumescent layer and the second intumescent layer is equal to or less than 6 mm.

In some arrangements, a combined thickness of the first intumescent layer and the second intumescent layer is equal to or less than 3 mm.

In some arrangements, a total thickness of the fire-rated wall joint seal is equal to or less than 10 mm.

In some arrangements, a total thickness of the fire-rated wall joint seal is equal to or less than 5 mm.

In some arrangements, the thickness of the first intumescent layer is equal to or substantially equal to the thickness of the second intumescent layer.

In some arrangements, the thickness of the first intumescent layer and the thickness of the second intumescent layer are each about 1.5 mm.

In some arrangements, a width of the fire-rated wall joint seal is between 1/2 inch and 6 inches.

In some arrangements, a width of the first intumescent layer and a width of the second intumescent layer are substantially equal.

In some arrangements, a width of the first intumescent layer is less than a width of the second intumescent layer.

In some arrangements, the width of the first intumescent layer is 50 percent or less of the width of the second intumescent layer.

In some arrangements, a portion of the adhesive joint that attaches the first intumescent layer and the second intumescent layer is exposed and is configured to allow the fire-rated wall joint seal to be attached to a component of a wall assembly.

In some arrangements, the first intumescent layer is positioned along an intermediate portion of the width of the second intumescent layer such that the portion of the adhesive joint that is exposed is located on each side of the first intumescent layer.

In some arrangements, a bead having a first portion extending is attached to the second intumescent layer along the portion of the adhesive joint that is exposed. The bead has a second portion that is or comprises a hollow gasket extending along an edge surface of the second intumescent layer.

In some arrangements, the first intumescent layer is positioned along an edge portion of the width of the second intumescent layer such that the portion of the adhesive joint that is exposed is located only on one side of the first intumescent layer.

In some arrangements, an adhesive layer extends along a portion or an entirety of the second side surface of one of the first intumescent layer and the second intumescent layer.

In some arrangements, the first intumescent layer and the second intumescent layer form a multi-layer intumescent strip, which is attached to a support layer.

In some arrangements, the support layer comprises a first portion that extends along a portion or an entirety of the second side surface of the second intumescent layer. The support layer includes a second portion that extends beyond the second intumescent layer in a width direction of the second intumescent layer. An adhesive layer is attached to the second portion.

In some arrangements, the adhesive layer is defined by a double-sided foam tape.

In some arrangements, the second portion is aligned with or offset from the first portion.

In some arrangements, the support layer comprises a hollow gasket extending along an edge surface of the multi-layer intumescent strip.

In some arrangements, a width of the support layer is greater than a width of the multi-layer intumescent strip.

In some arrangements, a width of the support layer is greater than a width of one or both of the first intumescent layer and the second intumescent layer.

An aspect of the present disclosure involves the fire-rated wall joint seal assembled within a joint of a wall assembly having a frame including a header track, a footer track, and a plurality of studs. The wall assembly further includes at least one wallboard attached to the plurality of studs on one or both sides of the wall assembly.

In some arrangements, the fire-rated wall joint seal is positioned between the frame and the at least one wallboard.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings.

FIG. 1 is a perspective view of a fire-rated joint component having multiple layers of intumescent material.

FIG. 2 is an enlarged view of a portion of the fire-rated joint component of FIG. 1.

FIG. 3 is a sectional view of a wall assembly incorporating the fire-rated joint component of FIG. 1 at the head-of-wall deflection gap on each side of the wall assembly to create a fire-rated head-of-wall joint.

FIG. 4 illustrates the wall assembly of FIG. 3 under the conditions of a fire test illustrating the expansion characteristics of the fire-rated joint component.

FIG. 5 is a sectional view of another fire-rated joint component.

FIG. 6 is a sectional view of a wall assembly incorporating the fire-rated joint component of FIG. 5 at the head-of-wall deflection gap on each side of the wall assembly to create a fire-rated head-of-wall joint.

FIG. 7 is a sectional view of another fire-rated joint component.

FIG. 8 is a sectional view of a wall assembly incorporating the fire-rated joint component of FIG. 7 at the head-of-wall deflection gap on each side of the wall assembly to create a fire-rated head-of-wall joint.

FIG. 9 is a sectional view of another fire-rated joint component.

FIG. 10 is a sectional view of a wall assembly incorporating the fire-rated joint component of FIG. 9 at the head-of-wall deflection gap on each side of the wall assembly to create a fire-rated head-of-wall joint.

FIG. 11 is a sectional view of another fire-rated joint component.

FIG. 12 is a sectional view of a wall assembly incorporating the fire-rated joint component of FIG. 11 at the head-of-wall deflection gap on each side of the wall assembly to create a fire-rated head-of-wall joint.

FIG. 13 is a sectional view of another fire-rated joint component.

FIG. 14 is a sectional view of a wall assembly incorporating the fire-rated joint component of FIG. 13 at the head-of-wall deflection gap on each side of the wall assembly to create a fire-rated head-of-wall joint.

### DETAILED DESCRIPTION

Embodiments of systems, components and methods of assembly and manufacture will now be described with reference to the accompanying figures, wherein like numerals refer to like or similar elements throughout. Although several embodiments, examples and illustrations are disclosed below, it will be understood by those of ordinary skill in the art that the inventions described herein extend beyond the specifically disclosed embodiments, examples and illustrations, and can include other uses of the inventions and obvious modifications and equivalents thereof. The terminology used in the description presented herein is not intended to be interpreted in any limited or restrictive manner simply because it is being used in conjunction with a detailed description of certain specific embodiments of the inventions. In addition, embodiments of the inventions can comprise several novel features and no single feature is solely responsible for its desirable attributes or is essential to practicing the inventions herein described.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

As described in the background section, various manufacturers were able to provide a fire-rated joint up to 1-1/2” dynamic movement. One existing fire-rated joint component for providing such a fire-rated joint is marketed as the CEMCO Fire Gasket. Such products are commonly referred to, and can be referred to herein, as firestop or fireblock seals, strips, devices, or components. The terms firestop (or firestopping) and fireblock (or fireblocking) are commonly used although such products slow, but do not necessarily completely stop or block, fire from eventually passing through the protected joint. The Fire Gasket product utilizes a 3 mm thick intumescent strip. With a smaller 1-1/2” joint, the 3 mm thick intumescent tape provided ample fire protection and prevents heat and fire from passing through the joint to an extent sufficient to pass the UL 2079 fire test. However, with a 2” wide joint, the 3 mm thick intumescent tape was unable to provide enough fire protection to pass the UL 2079 fire test. The present inventor (also an inventor of the Fire Gasket fire-rated joint component) attempted to pass the UL 2079 fire test of a 2” wide joint with 3 mm thick intumescent strip several times to no avail.

A solution was discovered when, instead of using one strip of 3 mm thick intumescent strip (e.g., intumescent tape), the present inventor used two separate layers of 1.5 mm thick intumescent tape stacked one on top of the other. The build up of the two separate layers was the same thickness as the single 3mm thick intumescent tape, so it did not cause the drywall to flare away from the track any more than it did with the earlier version of the Fire Gasket product. However, the joint seal formed by two stacked layers of intumescent tape, having a total thickness of 3 mm, was able to pass the UL 2079 fire test in a 2” wide joint, whereas the 3 mm thickness single layer intumescent tape was not.

Without being limited to any particular theory, the present inventor believes that with a strip consisting of a single layer of intumescent material, the expansion takes place through a substantial entirety or the entire thickness of the strip, and, when that happens, although the heat transfer through the joint is slowed down, heat can still pass through the expanded intumescent. However, when using a strip having at least two layers of intumescent, the expansion will be initially confined to only the first layer closest to the source of heat, allowing the second layer to stay intact without expanding, or with less expansion than would occur in the corresponding portion of a single layer intumescent strip. The present inventor believes that this was a critical and unexpected discovery, especially with respect to behavior of the intumescent material on the non-fire side of the wall assembly.

In a fire test, such as the UL 2079 fire test, a temperature sensor, such as a thermocouple (TC), is placed directly on the exposed surface within the deflection gap. In the case of the Fire Gasket joint seal product, the TC is placed directly on the surface of the joint seal product. This TC reads the surface temperature of the joint. The fire test is failed if the TC temperature reading exceeds 325 degrees Fahrenheit (°F) above the ambient temperature within the duration of the test, according to the UL 2079 test requirements. The wider the joint, the more surface area through which the heat can transfer into the wall assembly and eventually to the other side of the wall assembly. This is why smaller joints are much easier to protect because less heat will pass through a smaller joint.

It was discovered in testing that by having two layers of intumescent, the present inventor believes that one layer will act as a sacrificial layer. The sacrificial layer will at least partially or fully expand before the next layer fully expands and, in some instances, before the next layer begins to expand or undergoes any significant expansion, thereby protecting the second layer. On the fire side, eventually both layers will fully expand but it’s like having time released fire protection. One layer expands and eventually falls out of the joint on the fire side and then the second layer expands and remains in the joint, in some instances for the duration of the fire test.

On the non-fire side, the inner layer will expand but that expansion will stay within the inner layer, at least initially or for an initial period of time. The inner layer will cause the outer layer to be pushed away from the heat source of the metal track. As the joint seal or firestop device pushes away from the fire, the surface of the firestop device gets cooler. This phenomenon is well documented within the testing. In our tests, the temperature readings of the TC(s) located on the surface of the firestop device drop substantially (e.g., up to 100°F) once the expansion of the inner layer begins. As a result, the temperature at the joint stays below the threshold temperature for the requisite amount of time (e.g., 2 hours) to pass the UL 2079 fire test, even in a 2” or larger joint.

The present inventor has observed that the inner layer of intumescent material will expand prior to the outer layer of intumescent material even if both layers of intumescent material have the same threshold activation temperature. The present inventor believes that this is because the inner layer of intumescent material, on the cold or non-fire side of the wall, is closer to the heat source and, thus, reaches the threshold activation temperature before the outer layer of intumescent material. The expansion of the inner layer of intumescent material acts as a thermal barrier that reduces heat transfer relative to the unexpanded state of the inner layer of intumescent material. Furthermore, the expansion of the inner layer of intumescent material physically moves the outer layer of intumescent material further from the heat source, further delaying the time for the outer layer of intumescent material to reach its threshold activation temperature. This phenomenon can be enhanced by utilizing an inner layer of intumescent material having a lower threshold activation temperature than the threshold activation temperature of the outer layer of intumescent material. Thus, the individual intumescent layers of the two-ply, or multi-ply, intumescent strips disclosed herein can be provided with different threshold activation temperatures to influence or control the relative timing of the expansion between the layers.

For convenience, the fire-rated joint seals, or firestop or fireblocks, that include at least two layers of intumescent material, or similar expandable fire-resistant material, disclosed herein can be referred to as a “two-ply” intumescent joint seal, firestop, or fireblock. Although illustrated as two-ply intumescent layer arrangements, it is possible that the joint seal could incorporate more than two layers of intumescent material. Accordingly, references to “two-ply” or two layers of intumescent material can refer to, or can be replaced with references to, two or more layers of intumescent material. The accompanying figures and figure descriptions illustrate a number of possible implementations of a two-ply intumescent fireblock constructed in accordance with the above-described concepts, and wall assemblies incorporating such fire blocks. As used herein, a firestop or fireblock seal, device or component is a component configured for use in a construction joint, such as a joint between walls or between a wall and another structure, and which slows, inhibits, or prevents the passage of heat or fire through the joint. The fire block devices or components disclosed herein preferably allow an assembly with the protected joint to pass the UL 2079 test requirements.

As used herein, “separate” intumescent layers or strips are layers or strips containing an intumescent material (or a similar expandable fire-resistant material) that are formed separately from one another and are secured together. The intumescent material of each layer is fully cured or substantially cured before the layers are attached to one another. The intumescent strips can be or include commercially-available intumescent tapes, such as an intumescent tape sold under the BlazeSeal™ brand name by Rectorseal Corporation of Houston, Texas. Other suitable intumescent materials are available from Hilti Corporation (Schaan, LI), Specified Technologies, Inc. (Somerville, NJ, USA), or Tenmat Inc. (Stretford, UK). At least some intumescent tape products include an intumescent material that is deposited onto a thin film. A side of the intumescent tape opposite the thin film can include an adhesive layer. In some cases, the adhesive layer is provided by a double-sided film tape. Accordingly, at least some intumescent tape products can include a film layer, an intumescent layer, and a double-sided film tape, which can include an adhesive layer on each side of a thin film carrier. One adhesive layer of the double-sided film tape is adhered to the intumescent layer. The opposite, exposed adhesive layer of the double-sided film tape can be used to attach the intumescent tape to another object. In some cases, the exposed adhesive layer can be covered by a liner or release paper until the tape is ready for use.

The two (or more) intumescent layers can be secured together by a suitable adhesive layer, which can be substantially thinner than the intumescent layers. Unless otherwise noted explicitly or by way of context, an adhesive layer can be or include a composite layer, which is formed of several sub-layers. As noted above, some commercially available intumescent tapes include a double-sided film tape, which can provide the adhesive layer that secures the two intumescent layers. Accordingly, the adhesive layer can contain sub-layers. Preferably, the sub-layers contribute to the adhesive function of the adhesive layer and the adhesive layer does not contain structural elements that are unrelated to the adhesive function. For example, a foam layer of substantial thickness relative to the intumescent layer(s) generally would not be included as an adhesive layer but would form its own layer that is separate from the adhesive. It is also possible for one intumescent layer to be formed and at least substantially cured and another layer formed on top of the first layer. Furthermore, two or more separate intumescent layers can be secured together by another structure, such as mechanically secured by a support structure or support layer, instead of or in addition to an adhesive layer.

One suitable double-sided film tape for attaching two or more intumescent layers is the tesa® 51970 double-sided film tape product sold by tesa SE of Hamburg, Germany. The tesa® 51970 tape product includes a polypropylene film carrier and a first adhesive layer on each side of the carrier. The tesa® 51970 tape product has a thickness of about 8.66 mils or about 0.22 mm. Other suitable double-sided film tapes can also be used. In such tapes, the carrier can be constructed from a variety of suitable types of films, such as those constructed from or including polyolefins (e.g., polypropylene, polyethylene), polyesters (e.g., PET), polyamides (e.g., nylon), polyvinyl chloride (PVC), fluoropolymers, thermoplastic elastomers, foamed or solid films, or reinforced or laminated films (e.g., scrim, mesh, or fibers). The film can include optional characteristics or enhancements, such as being oriented or non-oriented, perforated or micro-perforated, textured or smooth. A suitable thickness range can be, for example, between about 0.5 mil to about 20 mil (about 0.01 mm to about 0.5 mm or about 12 microns to about 500 microns). Suitable adhesive types can include acrylic, rubber, silicone, or synthetic resin adhesives.

The intumescent layers described herein can have substantially the same thickness unless otherwise indicated. However, the intumescent layers can also vary in thickness in some embodiments. As used herein, about the same thickness means within plus or minus 10% of the referenced value and substantially the same thickness can mean within a single digit rounding error or within the capabilities of normal manufacturing limitations with respect to the referenced value.

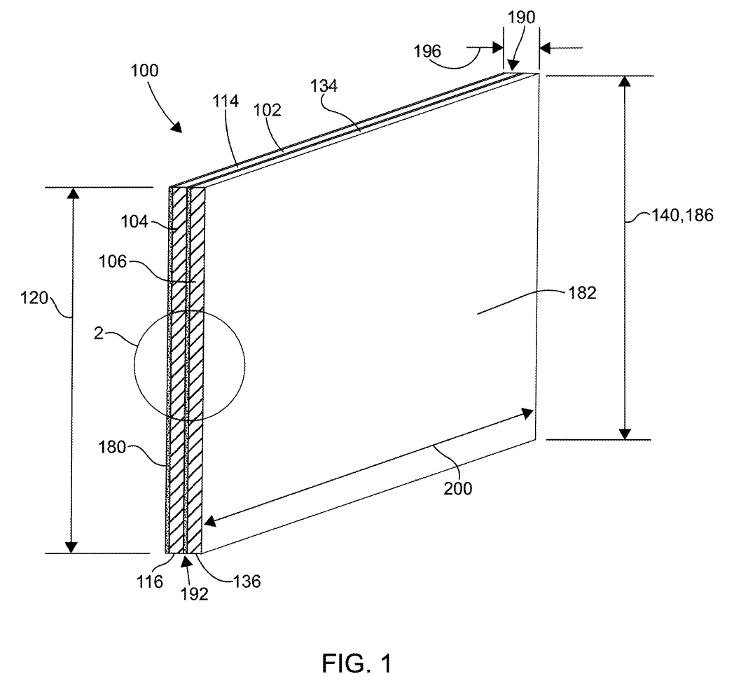

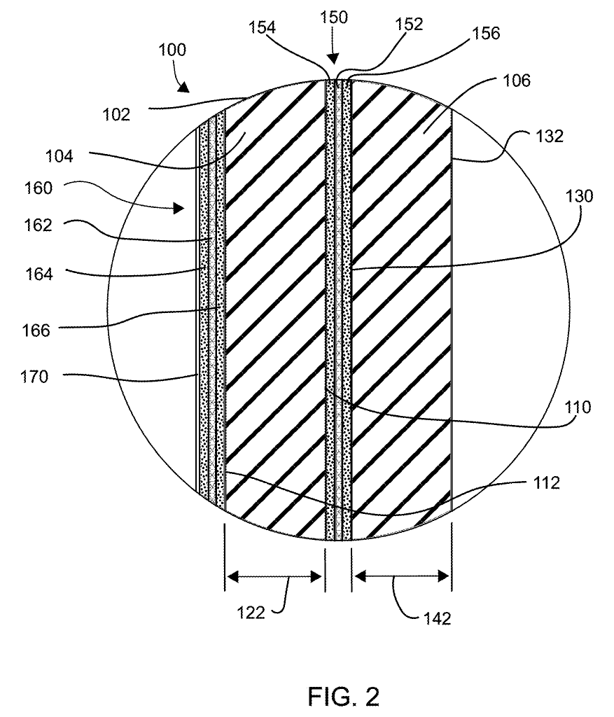

FIG. 1 illustrates a two-ply intumescent joint seal 100 (fireblock or firestop strip, device, or component) having two separate intumescent layers secured to one another to form a two-ply intumescent strip 102. FIG. 2 is an enlarged view of a portion of the two-ply intumescent joint seal 100 of FIG. 1. As illustrated, the two-ply intumescent joint seal 100 is formed by the two-ply intumescent strip 102, which has a first intumescent layer 104 and a second intumescent layer 106. As used herein, a strip refers to a thin, elongate structure having a relatively small thickness to width ratio. In other words, the thickness of a strip is generally less than about 25%, and may be less than about 10%, of the width of the strip. In some configurations, a strip can have a rectangular cross-sectional shape. In some configurations, a strip can have a consistent cross-sectional shape throughout a vast majority or an entirety of its length.

The first intumescent layer 104 and the second intumescent layer 106 are separately formed strips. In the illustrated arrangement, once separately formed as strips, the first intumescent layer 104 and the second intumescent layer 106 are positioned together in a stacked, or side-by-side, configuration. In the illustrated arrangement, the first intumescent layer 104 and the second intumescent layer 106 are aligned with one another in the stacked configuration, as opposed to being offset. However, in other arrangements, the first intumescent layer 104 and the second intumescent layer 106 can be offset from one another.

The first intumescent layer 104 includes a first side surface 110 and a second side surface 112 opposite the first side surface 110. The first intumescent layer 104 also includes a first edge surface 114 and a second edge surface 116 opposite the first edge surface 114. In the illustrated arrangement, the first side surface 110 and the second side surface 112 define a width 120 of the first intumescent layer 104. The first edge surface 114 and the second edge surface 116 define a thickness 122 of the first intumescent layer 104. Similarly, the second intumescent layer 106 includes a first side surface 130 and a second side surface 132 opposite the first side surface 130. The second intumescent layer 106 also includes a first edge surface 134 and a second edge surface 136 opposite the first edge surface 134. In the illustrated arrangement, the first side surface 130 and the second side surface 132 define a width 140 of the second intumescent layer 106. The first edge surface 134 and second edge surface 136 define a thickness 142 of the second intumescent layer 106.

In the illustrated arrangement, the first intumescent layer 104 and the second intumescent layer 106 are attached to one another along the first side surface 110 and the first side surface 130 to form the two-ply intumescent strip 102. The first intumescent layer 104 and the second intumescent layer 106 can be attached by any suitable arrangement, such as by an adhesive joint 150. As described previously, the first intumescent layer 104 and the second intumescent layer 106 are aligned such that the first edge surface 114 and the first edge surface 134 are aligned with one another and the second edge surface 116 and the second edge surface 136 are aligned with one another. The adhesive joint 150 can extend along a portion or an entirety of each of the first side surface 110 of the first intumescent layer 104 and the first side surface 130 of the second intumescent layer 106. In the illustrated arrangement, the adhesive joint 150 extends along a substantial entirety or an entirety of each of the first side surface 110 of the first intumescent layer 104 and the first side surface 130 of the second intumescent layer 106.

The adhesive joint 150 can be formed by any suitable arrangement. For example, the adhesive joint 150 can be formed by a single layer of a suitable adhesive material. However, in the illustrated arrangement, the adhesive joint 150 is or includes a double-sided film tape. As described previously herein, the double-sided film tape can include a carrier 152, a first adhesive layer 154 on a first side of the carrier 152, and a second adhesive layer 156 on a second side of the carrier 152. As used herein, two or more intumescent strips (e.g., the first intumescent layer 104 and the second intumescent layer 106) are directly connected to one another if they are connected by an adhesive joint 150 that does not include any additional component unrelated to the adhesive functionality of the adhesive joint 150.

The illustrated two-ply intumescent joint seal 100 includes an adhesive connector 160 that is configured to allow the two-ply intumescent joint seal 100 to be coupled to another object, such as to a structure that forms a construction joint. The adhesive connector 160 can extend along a portion or an entirety of the second side surface 112 of the first intumescent layer 104. However, in an alternative arrangement, the adhesive connector 160 can extend along a portion or an entirety of the second side surface 132 of the second intumescent layer 106. In the illustrated arrangement, the adhesive connector 160 extends along a substantial entirety or an entirety of the second side surface 112 of the first intumescent layer 104.

The adhesive connector 160 can be formed by any suitable arrangement. For example, the adhesive connector 160 can be formed by a single layer of a suitable adhesive material. However, in the illustrated arrangement, the adhesive connector 160 is or includes a double-sided film tape. As described previously herein, the double-sided film tape can include a carrier 162, a first adhesive layer 164 on a first side of the carrier 162, and a second adhesive layer 166 on a second side of the carrier 162. The first adhesive layer 164 couples the adhesive connector 160 to the first intumescent layer 104. The second adhesive layer 166 forms an exposed adhesive layer that allows the two-ply intumescent joint seal 100 to be coupled to another object. The second adhesive layer 166 can be covered by a liner or release layer 170 until the two-ply intumescent joint seal 100 is ready for use.

The two-ply intumescent strip 102 includes a first side surface 180 that is formed by the second adhesive layer 166 of the adhesive connector 160. The two-ply intumescent strip 102 includes a second side surface 182 that is formed by the second side surface 132 of the second intumescent layer 106. Accordingly, a width 186 of the two-ply intumescent strip 102 can be equal to the width 120 of the first intumescent layer 104 and/or the width 140 of the second intumescent layer 106, at least in embodiments such as the one shown in FIGS. 1 and 2 in which the first intumescent layer 104 and the second intumescent layer 106 are aligned.

The two-ply intumescent strip 102 includes a first edge surface 190 that is formed by a combination of the first edge surface 114 of the first intumescent layer 104 and the first edge surface 134 of the second intumescent layer 106. The two-ply intumescent strip 102 includes a second edge surface 192 that is formed by a combination of the second edge surface 116 of the first intumescent layer 104 and the second edge surface 136 of the second intumescent layer 106. The first edge surface 190 and the second edge surface 192 can also include respective portions of the adhesive joint 150 and the adhesive connector 160. However, as discussed below, preferably the adhesive joint 150 and the adhesive connector 160 have a small thickness and thus make only a minor contribution to the first edge surface 190 and the second edge surface 192. Accordingly, the two-ply intumescent strip 102 can have a thickness 196 that is close to the combination of the thickness 122 of the first intumescent layer 104 and the thickness 142 of the second intumescent layer 106. The thickness 196 can equal the combination of the thickness 122 of the first intumescent layer 104 and the thickness 142 of the second intumescent layer 106, along with the thickness of the adhesive joint 150 and the adhesive connector 160.

In some arrangements, a combination of the thickness 122 of the first intumescent layer 104 and the thickness 142 of the second intumescent layer 106 is equal to or greater than about 80 percent of the thickness 196 of the two-ply intumescent joint seal 100 or the two-ply intumescent strip 102. In some arrangements, the combination of the thickness 122 of the first intumescent layer 104 and the thickness 142 of the second intumescent layer 106 is equal to or greater than about 90 percent of the thickness 196 of the two-ply intumescent joint seal 100 or the two-ply intumescent strip 102. In some arrangements, the combination of the thickness 122 of the first intumescent layer 104 and the thickness 142 of the second intumescent layer 106 is equal to or greater than about 95 percent of the thickness 196 of the two-ply intumescent joint seal 100 or the two-ply intumescent strip 102. In some arrangements, the combination of the thickness 122 of the first intumescent layer 104 and the thickness 142 of the second intumescent layer 106 is equal to or greater than about 98 percent of the thickness 196 of the two-ply intumescent joint seal 100 or the two-ply intumescent strip 102. Accordingly, the two-ply intumescent strip 102 is formed primarily from the first intumescent layer 104 and the second intumescent layer 106 as a percentage of volume, with the adhesive joint 150 and the adhesive connector 160 forming a small portion of the overall volume of the two-ply intumescent strip 102.

In the illustrated arrangement, the two-ply intumescent joint seal 100 is formed by the two-ply intumescent strip 102 and, thus, the thickness 196 of the two-ply intumescent strip 102 is equivalent to the overall thickness of the two-ply intumescent joint seal 100. However, as described below, the two-ply intumescent joint seal 100 can include additional layers or components, such as a support layer, which can add to the overall thickness of the two-ply intumescent joint seal 100 relative to the thickness 196 of the two-ply intumescent strip 102.

In some arrangements, the combination of the thickness 122 of the first intumescent layer 104 and the thickness 142 of the second intumescent layer 106 is equal to or less than 6 mm. In some arrangements, the combination of the thickness 122 of the first intumescent layer 104 and the thickness 142 of the second intumescent layer 106 is equal to or less than 3 mm. In some arrangements, the thickness 196 of the two-ply intumescent strip 102 is equal to or less than 6 mm. In some arrangements, thickness 196 of the two-ply intumescent strip 102 is equal to or less than 3 mm. In some arrangements, a total thickness of the two-ply intumescent joint seal 100 is equal to or less than 10 mm. In some arrangements, a total thickness of the two-ply intumescent joint seal 100 is equal to or less than 5 mm. Such thicknesses are suitable for use in a wall assembly between the framing of the wall and the wallboard without causing an unacceptable build-up of thickness between the framing and the wallboard.

In some arrangements, the thickness 122 of the first intumescent layer 104 is equal to or substantially equal to the thickness 142 of the second intumescent layer 106. However, in other arrangements, the thickness 122 of the first intumescent layer 104 and the thickness 142 of the second intumescent layer 106 differ from one another. In some arrangements, the thickness 122 of the first intumescent layer 104 and the thickness 142 of the second intumescent layer 106 are each between about 0.5 mm and about 6 mm, or are each between about 1 mm and about 4 mm, or are each between about 1.5 mm and 3 mm. In some arrangements, one or both of the thickness 122 of the first intumescent layer 104 and the thickness 142 of the second intumescent layer 106 are about 3 mm, about 2.5 mm, about 2 mm, about 1.5 mm, or about 1 mm.

As described above, prior to the influx of data center construction, the average width for fire-rated joints was generally between 1/2” to 1-1/2”. However, some buildings, including some data centers, can require significantly greater allowable deflection. Such large deflection fire-rated joints can require a deflection that is greater than 1-1/2”, such as 2” to 6” of movement, or greater. The width 186 of the two-ply intumescent strip 102 and/or the overall width of the two-ply intumescent joint seal 100 can be configured to accommodate the desired amount of deflection movement. For example, the width 186 of the two-ply intumescent strip 102 and/or the overall width of the two-ply intumescent joint seal 100 can be equal to or somewhat (e.g., 5-10%) greater than the desired amount of deflection movement. In some arrangements, the width 186 of the two-ply intumescent strip 102 and/or the overall width of the two-ply intumescent joint seal 100 can be between about 1/2” and about 6”, or greater. In some arrangements, the width 186 of the two-ply intumescent strip 102 and/or the overall width of the two-ply intumescent joint seal 100 can be between about 2” and about 6”, between about 3” and about 6”, or between about 4” and about 6”. In some arrangements, the width 186 of the two-ply intumescent strip 102 and/or the overall width of the two-ply intumescent joint seal 100 can be about 2”, about 3”, about 4”, about 5”, or about 6”, or greater.

In some arrangements, including the two-ply intumescent joint seal 100 of FIGS. 1 and 2, the width 120 of the of the first intumescent layer 104 and the width 140 of the second intumescent layer 106 are substantially equal. However, in other arrangements, such as some of those described below, the width 120 of the of the first intumescent layer 104 and the width 140 of the second intumescent layer 106 can differ.

The two-ply intumescent joint seal 100 and/or the two-ply intumescent strip 102 can define a length 200. The two-ply intumescent joint seal 100 can be provided as a roll, similar to a roll of tape. The roll can provide any suitable length of the two-ply intumescent joint seal 100, such as between 10-50 or 75+ feet. The provided length will likely be limited by consideration of the maximum diameter of the roll that still allows the roll to be reasonably convenient to handle in the field. Alternatively, the two-ply intumescent joint seal 100 can be provided in strips, such as strips of between about 5 feet and 25 feet in length, including about 5, 10, 12, or 16 feet in length. In other arrangements, the two-ply intumescent joint seal 100 can be factory-applied to a construction element, such as a header track, a footer track, or another frame member.

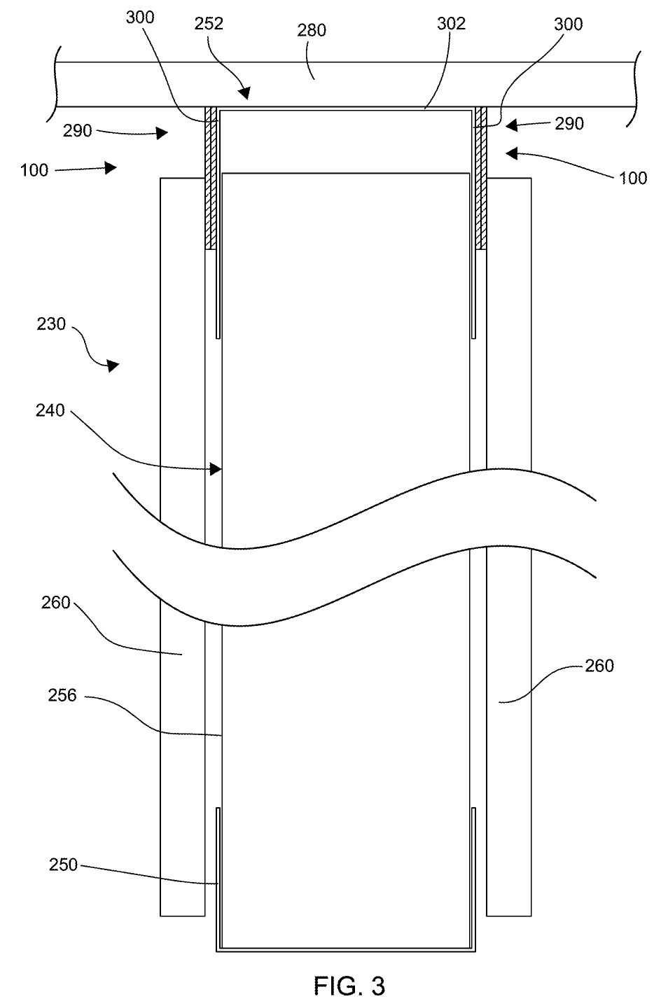

FIG. 3 illustrates a wall assembly 230, or a wall, that incorporates a two-ply intumescent joint seal 100 on each side of the wall assembly 230. The illustrated wall assembly 230 is a metal stud wall having a frame assembly 240, which can also be referred to as a frame or framing. The illustrated frame assembly 240 includes a footer track 250, a header track 252, and a plurality of studs 256 extending between the footer track 250 and the header track 252. The wall assembly 230 also includes one or more wallboards 270 on one or both sides of the wall assembly 230 and attached to the frame assembly 240. The wall assembly 230 extends between a floor (not shown) and a ceiling 280, which can be the floor of a higher level of a multi-level or multi-story building.

The wall assembly 230 includes a dynamic head-of-wall arrangement in which movement is permitted between the header track 252 attached to the ceiling 280 and a remaining portion of the wall assembly 230, including the footer track 250, the studs 256, and the wallboard 270. An upper end of the studs 256 and an upper end of the wallboard 270 are spaced from the ceiling 280 to permit the relative movement. A deflection gap 290 is defined between the upper edge surface of the wallboard 270 and the lower surface of the ceiling 280. It is the joint between the upper portion of the wall assembly 230 and the ceiling 280 that is protected by the two-ply intumescent joint seal 100. Because of the deflection gap 290 and permitted movement, the joint can be referred to as a dynamic joint. However, the joint (static or dynamic) can be located between any two portions of any type of wall assembly.

As discussed previously herein, the deflection gap 290 can be up to or greater than about 6” as measured between the upper edge surface of the wallboard 270 and the lower surface of the ceiling 280. As also discussed herein, it can be difficult for existing fireblock devices to pass a fire test in a deflection gap 290 that is greater than about 1-1/2” or about 2”. This significant distance between the upper edge surface of the wallboard 270 and the ceiling 280 provides a substantial surface area for heat to pass through the wall assembly 230. As will be understood by those skilled in the art, the wall assembly 230 is usually built with the upper edge surface of the wallboard 270 in a neutral position that is spaced from the ceiling 280 about halfway from its maximum spacing or its fully open position. From the neutral position, the upper edge surface of the wallboard 270 can move toward and away from the ceiling 280.

The two-ply intumescent joint seal 100 is positioned within the wall assembly 230 to protect the deflection gap 290. In the illustrated arrangement, a two-ply intumescent joint seal 100 is provided on each side of the wall assembly 230 to protect the deflection gap 290 on each side of the wall assembly 230. However, in other arrangements, an alternative fireblock arrangement could be provided on one side of the wall assembly 230. Preferably, the wall assembly 230 incorporating one or more of the two-ply intumescent joint seals 100 can provide sufficient protection to the deflection gap 290 to allow the wall assembly 230 to pass the UL 2079 fire test. The two-ply intumescent joint seal 100 can be assembled in the same manner on each side of the wall assembly 230. Accordingly, descriptions herein of the two-ply intumescent joint seal 100 on one side of the wall assembly 230 can apply to the other side of the wall assembly 230 unless otherwise specified.

In the illustrated arrangement, the two-ply intumescent joint seal 100 is secured to a leg or flange 300 of the header track 252 that extends downwardly from a web 302 of the header track 252. Preferably, the two-ply intumescent joint seal 100 is positioned adjacent the ceiling 280 on the flange 300 of the header track 252. Furthermore, an upper end portion of the wallboard 270 overlaps the two-ply intumescent joint seal 100. The wallboard 270 slides along the two-ply intumescent joint seal 100 during deflection movement. In the illustrated arrangement, a two-ply intumescent joint seal 100 is provided on each side of the wall assembly 230. The two-ply intumescent joint seal 100 on each side of the wall assembly 230 provides sufficient protection to allow the wall assembly 230 to pass the UL 2079 fire test.

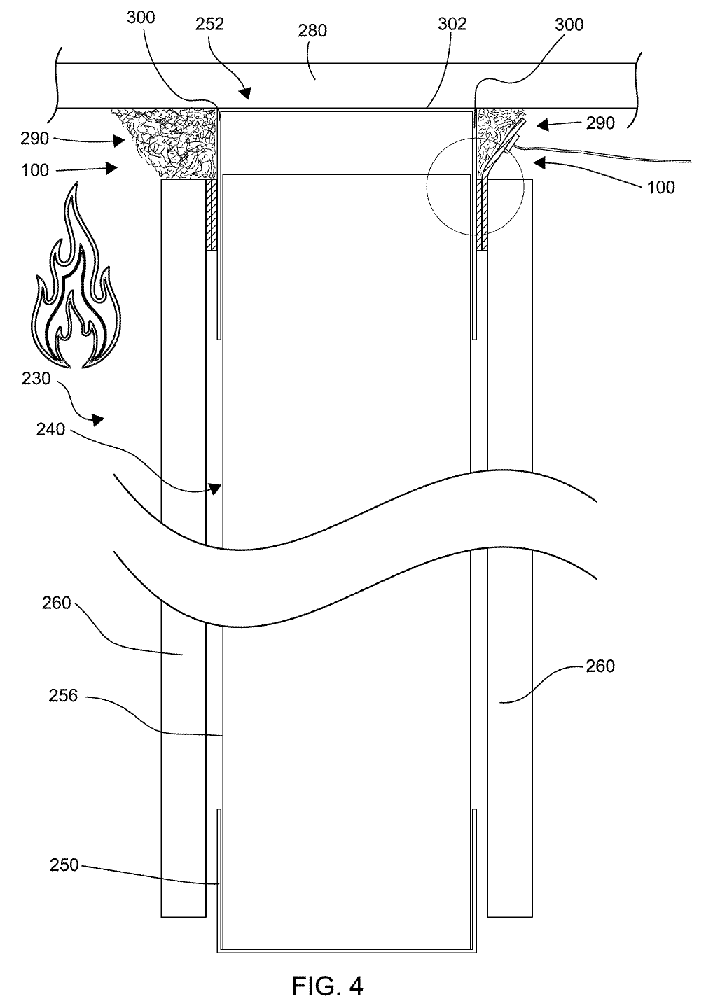

FIG. 4 illustrates the wall assembly 230 of FIG. 3 in the context of a fire test, such as the UL 2079 fire test. In FIG. 4, the left side of the wall assembly 230 is the hot side or fire side and the right side of wall assembly 230 is the cold side or non-fire side. A thermocouple (TC) is applied to the two-ply intumescent joint seal 100 on the cold side of the wall assembly 230. The TC senses or determines a temperature within the deflection gap 290, which can be a surface temperature of the two-ply intumescent joint seal 100.

As illustrated, the first intumescent layer 104 and the second intumescent layer 106 of the two-ply intumescent joint seal 100 on the hot side of the wall assembly 230 have expanded in response to reaching or exceeding the threshold temperature to cause activation or expansion of the intumescent material. The threshold temperature can be between about 350°F and about 400°F. However, in other configurations, the threshold temperature to cause expansion of the intumescent material can be lower (e.g., 300°F) or higher (e.g., 430°F to 480°F or greater). The expanded intumescent material creates a barrier that slows heat transfer through the wall assembly 230, in particular through the deflection gap 290.

Furthermore, as illustrated, the first intumescent layer 104 on the cold side of the wall assembly 230 has started to expand while the second intumescent layer 106 has not expanded or is in a state of less expansion than the first intumescent layer 104. As described previously, the present inventor has observed that during a fire test, the first intumescent layer 104, which is closer to the fire side, the header track 252, or other portions of the frame assembly 240 than the second intumescent layer 106, reaches the threshold temperature and begins to expand prior to the second intumescent layer 106 reaching the threshold temperature and beginning to expand. The second intumescent layer 106 may not expand, or not expand to any significant extent, or may expand less than the first intumescent layer 104 – at least during the duration of a fire test, which can last about 2 hours. As discussed above, the timing and/or degree of expansion can be further influenced by selecting intumescent materials for the first intumescent layer 104 and the second intumescent layer 106 having different threshold activation temperatures.

It has been observed that a relatively inner intumescent strip (closer to the hot side) will expand sooner and/or to a greater extent than a relatively outer intumescent strip. It is believed that the expansion of the relatively outer intumescent strip will be less than the expansion of a corresponding outer portion of a single layer intumescent strip of the same or comparable thickness. It is believed that this lesser expansion of the relatively outer intumescent strip, compared to the relatively inner intumescent strip or to the outer portion of a single layer intumescent strip of the same or comparable thickness, permits the two-ply intumescent joint seal 100, or another joint seal that incorporates a multi-layer intumescent strip, to perform better in a fire test than a joint seal that includes a single layer intumescent strip of the same or comparable thickness. In other words, the two-ply intumescent joint seal 100 maintains the TC at a lower temperature than what would occur with a single layer intumescent strip of the same or comparable thickness. In the experience of the present inventor, the two-ply intumescent joint seal 100 has permitted the wall assembly 230 to pass the UL 2079 fire test.

It has been observed that the expansion of the inner intumescent strip displaces the outer intumescent strip away from the heat source (on the cold side of the wall) and forms a thermally insulating barrier that delays expansion and degradation of the second intumescent layer. That is, the inner intumescent strip function as a sacrificial layer that undergoes substantial expansion and structural degradation prior to expansion of the second intumescent layer. The expansion of the inner intumescent layer forms an expanded char layer that acts as a thermal barrier reducing heat transfer to and protecting the second intumescent layer, thus maintaining its structural integrity for a longer duration than the first intumescent layer during fire exposure. In some configurations, the first intumescent layer reaches maximum expansion prior to initiation of expansion of the second intumescent layer. The expansion of the inner intumescent layer also increases the distance between the outer intumescent layer and the heat source during fire exposure, which reduces the temperature of the TC that is attached to or is located adjacent the outer intumescent layer. The second intumescent layer can also limit the passage of hot gases through the joint after expansion of the first intumescent layer. Accordingly, the first intumescent layer and the second intumescent layer are configured to expand sequentially rather than simultaneously, either by the positioning relative to the heat source or by the selection of the threshold activation temperature of the intumescent material of each strip, or both.

In one example, the present inventor conducted a fire test in accordance with ASTM E119 and UL 2079 using a two-ply intumescent joint seal 100 constructed substantially as shown and described in connection with FIGS. 1 and 2 to protect a 2” joint in a wall assembly. Each of the first intumescent layer 104 and the second intumescent layer 106 was 1.5 mm thick (corresponding to the thickness 122 and the thickness 142). The wall assembly included a second 2” joint that was protected by a single-ply or single layer intumescent strip having a thickness of 3 mm (equal to the combined thickness of two intumescent layers of the two-ply intumescent joint seal 100). Each of the joints was located in an intermediate portion of the wall assembly (not at the head-of-wall) to provide an accurate comparison. The single-ply intumescent strip was provided in the relative upper joint and the two-ply intumescent joint seal 100 was provided in the relative lower joint. It is believed that the difference in location in the intermediate portion of the wall did not affect the performance of the intumescent strips.

In the fire test, the upper, single-ply intumescent strip joint failed at approximately 90 minutes because two of five total TC’s indicated a temperature greater than the allowable temperature of 325 degrees Fahrenheit (°F) above the ambient temperature. The highest temperature indicated by a TC in the upper, single-ply intumescent strip joint exceeded the allowable temperature by over 175°F. The temperature indicated by the other TC in the upper, single-ply intumescent strip joint that exceeded the allowable temperature (the lower of the two failing TC’s) exceeded it by 95°F. The lower, two-ply intumescent joint seal 100 joint passed the two hour test with all five TC’s indicating a temperature significantly below the allowable temperature of 325°F above the ambient temperature. In fact, the highest temperature indicated by a TC in the lower, two-ply intumescent joint seal 100 joint was below the allowable temperature by 70°F. The average temperature of all five TC’s in the lower, two-ply intumescent joint seal 100 joint was below the allowable temperature by nearly 100°F. The differential between the highest temperature indicated by a TC in the upper, single-ply intumescent strip joint and the highest temperature indicated by a TC in the lower, two-ply intumescent joint seal 100 joint was over 245°F.

In another example, the present inventor conducted a fire test in accordance with ASTM E119 and UL 2079 using a two-ply intumescent joint seal 100 constructed substantially as shown and described in connection with FIGS. 1 and 2 to protect a 2” joint in a head-of-wall assembly. The head-of-wall assembly was constructed substantially as shown and described in connection with FIGS. 3 and 4. Each of the first intumescent layer 104 and the second intumescent layer 106 was 1.5 mm thick (corresponding to the thickness 122 and the thickness 142). The head-of-wall deflection joint protected by the two-ply intumescent joint seal 100 passed the fire test with no TC indicating a temperature above the allowable temperature of 325°F above the ambient temperature. The highest temperature indicated by a TC was below the allowable temperature by over 50°F. The average temperature of all five TC’s was below the allowable temperature by nearly 150°F. The inventor noted that the outer intumescent strip had no visible sign of expansion.

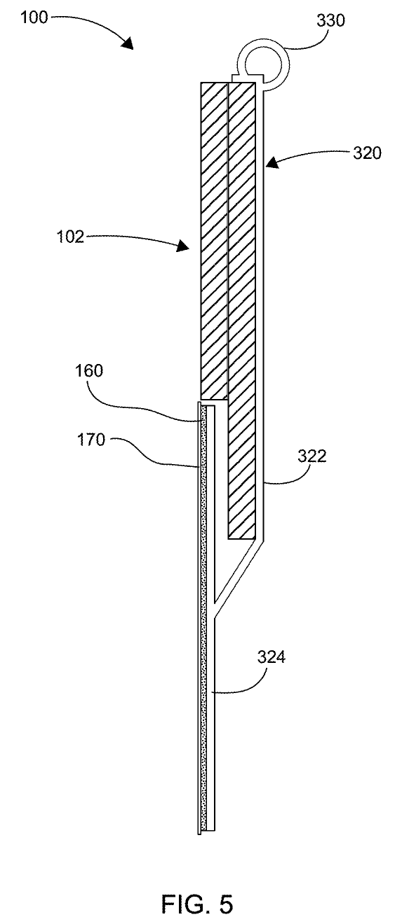

FIGS. 5-14 illustrate alternative versions of a two-ply intumescent joint seal 100 that incorporate a two-ply intumescent strip 102, and related wall assemblies, that the present inventor believes will operate in a manner similar to the joint seal 100 shown and described in connection with FIGS. 1-4. Unless otherwise indicated, the two-ply intumescent strip 102 of the following versions of the two-ply intumescent joint seal 100 can be the same as or similar to the two-ply intumescent strip 102 described in connection with FIGS. 1-4, or can be of another suitable arrangement. For example, the separate intumescent layers of the two-ply intumescent strip 102 can be attached to one another by any suitable arrangement, or can be secured in a stacked relationship by any suitable arrangement, such as by a support structure, without being attached to one another.

FIG. 5 illustrates two-ply intumescent joint seal 100 that includes a two-ply intumescent strip 102 attached to a support, support layer, or support structure, which can be in the form of a carrier 320. The carrier 320 can also be referred to as a profile or profile layer. The carrier 320 can be an elongate, extrusion having a consistent cross-sectional shape along a substantial entirety or an entirety of its length. The carrier 320 can be flexible, but the illustrated two-ply intumescent joint seal 100 is unlikely to be provided as a roll. Rather, the two-ply intumescent joint seal 100 including the carrier 320 can be provided in suitable lengths, such as between about 5 feet and 25 feet in length, including about 5, 10, 12, or 16 feet in length.

The carrier 320 can be constructed of any suitable material, such as a polymer material. In some configurations, the carrier 320 is constructed of a vinyl material. However, other suitable non-metal or plastic/polymeric materials can be used, such as polyvinyl chloride (PVC) or polyethylene. In some configurations, the carrier 320 could be constructed from a metal material. However, metal materials reduce flexibility in comparison to plastics and increase cost. Accordingly, for many applications, it is preferred for the carrier 320 to be constructed in whole or in part by a plastic/polymeric material.

The carrier 320 includes a first portion or a first leg 322 and a second portion or a second leg 324. The first leg 322 and the second leg 324 are spaced apart from one another in a thickness direction of the two-ply intumescent joint seal 100. A lower, angled portion of the first leg 322 connects the first leg 322 to the second leg 324. The first leg 322 extends along the second side surface 132 of the second intumescent layer 106. In the illustrated arrangement, the first leg 322 covers an entirety or a substantial entirety of the second side surface 132.

In addition to being spaced apart from the first leg 322 in the thickness direction, the second leg 324 is offset in the width direction to extend below a lowermost extent of the first leg 322. Accordingly, an overall width of the two-ply intumescent joint seal 100 is greater than the width 186 of the two-ply intumescent strip 102 and, therefore, is greater than the width 120 of the first intumescent layer 104 and the width 140 of the second intumescent layer 106. In the illustrated arrangement, the upper portion of the second leg 324 overlaps a lower portion of the first leg 322. The second leg 324 can include an adhesive connector 160 on an opposite side relative to the first leg 322. The adhesive connector 160 can cover a portion or an entirety of the side surface of the second leg 324. A surface of the adhesive connector 160 can be aligned or substantially aligned with the second side surface 112 of the first intumescent layer 104 to be in or substantially in a common plane. The adhesive connector 160 is configured to allow the two-ply intumescent joint seal 100 to be attached to another object, such as a portion of a wall assembly 230. A liner or release layer 170 can cover the adhesive connector 160 until the two-ply intumescent joint seal 100 is ready for use. In addition or in the alternative, the two-ply intumescent strip 102 (e.g., the first intumescent layer 104) can include an adhesive connector 160 (and liner or release layer 170).

The two-ply intumescent joint seal 100 can include a structure or feature that facilitates the creation of a seal with an adjacent structure, which can be the ceiling 280. In the illustrated arrangement, the carrier 320 includes a sealing element in the form of a hollow gasket 330, which can also be referred to as a bubble gasket. In the illustrated arrangement, an upper end of the first leg 322 includes a return flange that extends at least partially over the second intumescent layer 106 or the second intumescent layer 106 and the first intumescent layer 104 of the two-ply intumescent strip 102. The hollow gasket 330 can attach to the first leg 322 at the return and the upper end of the vertical portion of the first leg 322. The hollow gasket 330 can compress against the ceiling 280 to facilitate the two-ply intumescent joint seal 100 sealing against the ceiling 280 or another adjacent structure.

In the illustrated arrangement, the width 120 of the first intumescent layer 104 is different than the width 140 of the second intumescent layer 106. In particular, the width 120 of the first intumescent layer 104 is less than the width 140 of the second intumescent layer 106. The width 120 of the first intumescent layer 104 can be between about 1/4 to about 7/8 or between about 2/3 to about 3/4 of the width 140 of the second intumescent layer 106. The smaller width 120 of the first intumescent layer 104 provides additional space for the second leg 324 of the carrier 320. In addition, intumescent material is expensive relative to the typical material(s) used to form the carrier 320. Accordingly, reducing the amount of intumescent material in the two-ply intumescent joint seal 100 reduces the manufacturing cost. The illustrated two-ply intumescent joint seal 100 provides a sufficient amount of intumescent material in the first intumescent layer 104 to sufficiently protect the associated construction joint and reduces costs by providing less intumescent material in comparison to a two-ply intumescent strip 102 in which the width 120 of the first intumescent layer 104 and the width 140 of the second intumescent layer 106 are the same.

In the illustrated arrangement, the thickness 122 of the first intumescent layer 104 is the same as or substantially the same as the thickness 142 of the second intumescent layer 106. However, in other arrangements, the thickness 122 of the first intumescent layer 104 can be different from (e.g., larger than or smaller than) the thickness 142 of the second intumescent layer 106.

In the arrangement of FIG. 5, the two-ply intumescent joint seal 100 is configured to be attached to another object by the adhesive connector 160, which is attached to the carrier 320. However, in an alternative arrangement, the carrier 320 can be provided primarily to provide the two-ply intumescent joint seal 100 with a structure or feature that facilitates the creation of a seal with an adjacent structure, which can be the ceiling 280a. In the illustrated arrangement, that structure is the hollow gasket 330. In such an arrangement, the two-ply intumescent joint seal 100 can be coupled to another structure (e.g., a header track 252 or other portion of a frame assembly 240) in an alternative manner. For example, the adhesive connector 160 could be connected to the first intumescent layer 104 in a manner similar to the two-ply intumescent joint seal 100 of FIGS. 1 and 2. In such an arrangement, a lower end of the first leg 322 of the carrier 320 can terminate at or vertically above the second edge surface 136 of the second intumescent layer 106, which can define the lowermost extent of the second intumescent layer 106, and the second leg 324 can be omitted. In some arrangements, the leg 322 can cover only a portion of the second side surface 132 of the second intumescent layer 106, such as only about an upper 1/10 to 1/3 or only about an upper 1/10 to 1/4 of the second intumescent layer 106.

In some versions of this alternative arrangement, the width 120 of the first intumescent layer 104 can be less than the width 140 of the second intumescent layer 106. In some arrangements, the width 120 of the first intumescent layer 104 can be between about 1/6 to about 1/2 or between about 1/4 to about 1/3 of the width 140 of the second intumescent layer 106. In some arrangements, the width 120 of the first intumescent layer 104 can be less than about 1/3, about 1/4, or about 1/5 of the width 140 of the second intumescent layer 106. In another alternative arrangement, the leg 322 of the carrier 320 can be positioned along the second side surface 112 of the first intumescent layer 104 or, if the first intumescent layer 104 is sufficiently narrower than the second intumescent layer 106, along the first side surface 110 of the second intumescent layer 106 or along an exposed portion of an adhesive joint 150 between the first intumescent layer 104 and the second intumescent layer 106. In such an arrangement, the smaller width 120 of the first intumescent layer 104 would allow the adhesive joint 150 to function not only to couple the first intumescent layer 104 to the second intumescent layer 106, but to attach the two-ply intumescent joint seal 100 to another object, such as a header track 252 or another portion of a frame assembly 240. The first intumescent layer 104 could be located centrally or intermediately within or relative to the portion of the second intumescent layer 106 that is not covered by the carrier 320.

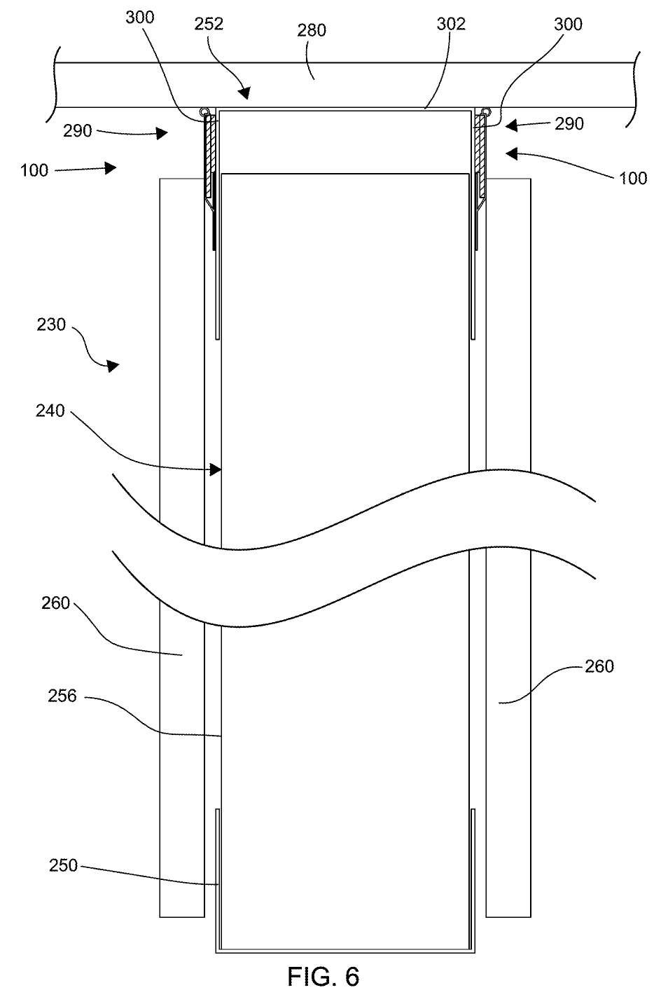

FIG. 6 illustrates a pair of the two-ply intumescent joint seals 100 of FIG. 5 assembled into a wall assembly 230 in a manner similar to or the same as the wall assembly 230 described in connection with FIG. 3. In particular, one of the two-ply intumescent joint seal 100 is provided in the deflection gap 290 on each side of the wall assembly 230. Each two-ply intumescent joint seal 100 is attached to a flange 300 of the header track 252 and is positioned between the header track 252 and the wallboard 270. An upper end of the two-ply intumescent joint seal 100 is positioned adjacent the ceiling 280 such that the hollow gasket 330 preferably contacts the ceiling 280 to provide a seal between the two-ply intumescent joint seal 100 and the ceiling 280. However, the two-ply intumescent joint seal 100 can also be used to protect other construction joints, such as the joint at the bottom of the wall assembly 230 (the two-ply intumescent joint seal 100 attached to the footer track 250), a joint between the wall assembly 230 and another structure (which can be another wall), or a joint in an intermediate location within a wall assembly 230 (in which case the two-ply intumescent joint seal 100 can be attached to a suitable member of the frame assembly 240, such as a stud 256).

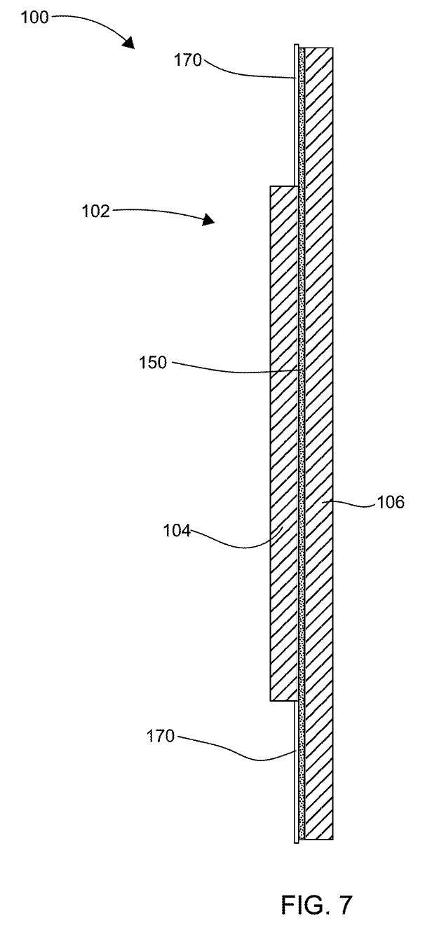

FIG. 7 illustrates a two-ply intumescent joint seal 100 that is formed of or includes a two-ply intumescent strip 102. As described previously with respect to FIGS. 1 and 2, the two-ply intumescent strip 102 includes a first intumescent layer 104 and a second intumescent layer 106 attached to one another, such as by adhesive joint 150. One of the first intumescent layer 104 and the second intumescent layer 106 has a width that is less than the other intumescent layer 104, 106. In the illustrated arrangement, similar to the two-ply intumescent strip 102 of FIG. 5, the width 120 of the first intumescent layer 104 is less than the width 140 of the second intumescent layer 106.

The first intumescent layer 104 is positioned centrally or intermediately relative to the second intumescent layer 106 such that a portion of the second intumescent layer 106 is positioned on each side of the first intumescent layer 104. This arrangement creates an exposed portion of the adhesive joint 150 on each side of the first intumescent layer 104, which can be used to attach the two-ply intumescent joint seal 100 to another object, such as the frame assembly 240 of a wall assembly 230. Each of the exposed portions of the adhesive joint 150 can be covered by a liner or release layer 170 until the two-ply intumescent joint seal 100 is ready for use. Alternatively, a single liner or release layer 170 can cover both of the exposed portions of the adhesive joint 150, along with the first intumescent layer 104.

In some configurations, the width 120 of the first intumescent layer 104 can be between about 1/4 to about 7/8 or between about 2/3 to about 3/4 of the width 140 of the second intumescent layer 106. In some configurations, the width 120 of the first intumescent layer 104 can be at least about 1/2 of the width 140 of the second intumescent layer 106, or at least about 2/3 of the width 140 of the second intumescent layer 106.

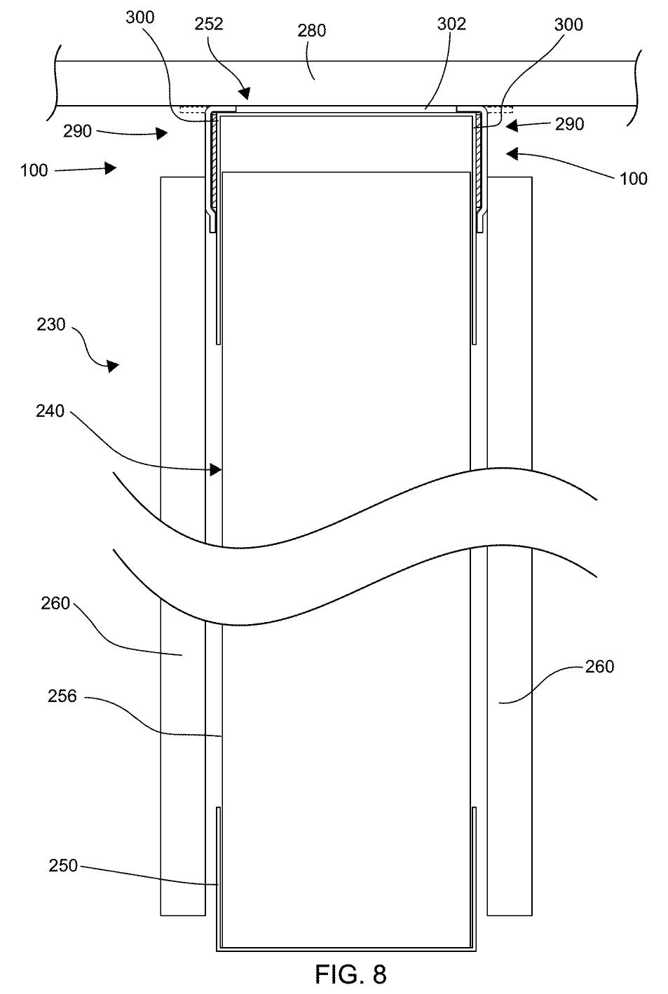

FIG. 8 illustrates a pair of the two-ply intumescent joint seals 100 of FIG. 7 assembled into a wall assembly 230 in a manner similar to or the same as the wall assemblies 230 described previously. In particular, one of the two-ply intumescent joint seals 100 is provided in the deflection gap 290 on each side of the wall assembly 230. Each two-ply intumescent joint seal 100 is attached to a flange 300 of the header track 252 and is positioned between the header track 252 and the wallboard 270. However, in the illustrated arrangement of FIG. 8, an upper end of the two-ply intumescent joint seal 100 is attached to either the web 302 of the header track 252 (shown in solid line) or the ceiling 280 (shown in dashed line). Such an arrangement allows the two-ply intumescent joint seal 100 to be installed to the header track 252 prior to attachment of the header track 252 to the ceiling 280 or to be installed after the header track 252 has been attached to the ceiling 280. As discussed previously, the two-ply intumescent joint seal 100 can also be used to protect other construction joints, such as the joint at the bottom of the wall assembly 230, a joint between the wall assembly 230 and another structure, or a joint in an intermediate location within a wall assembly 230.

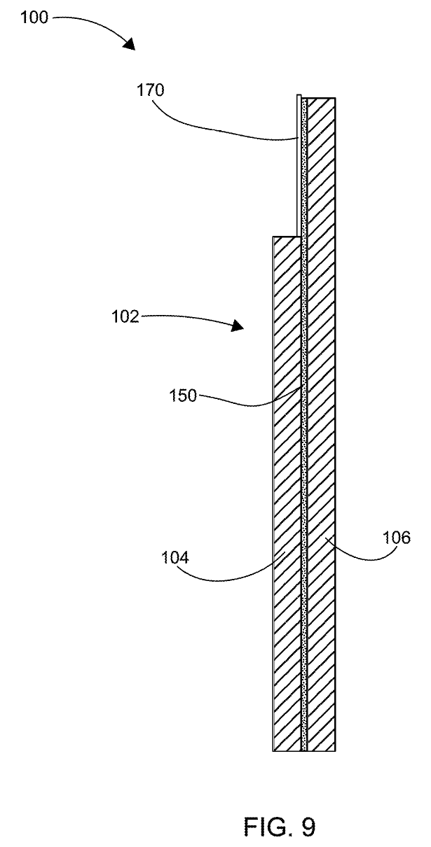

FIG. 9 illustrates a two-ply intumescent joint seal 100 that is formed of or includes a two-ply intumescent strip 102. As described previously at least with respect to FIGS. 1 and 2, the two-ply intumescent strip 102 includes a first intumescent layer 104 and a second intumescent layer 106 attached to one another, such as by adhesive joint 150. One of the first intumescent layer 104 and the second intumescent layer 106 has a width that is less than the other intumescent layer 104, 106. In the illustrated arrangement, the width 120 of the first intumescent layer 104 is less than the width 140 of the second intumescent layer 106.

The first intumescent layer 104 is positioned along one side or toward one edge of the second intumescent layer 106 such that a portion of the second intumescent layer 106 is positioned on one side of the first intumescent layer 104. This arrangement creates an exposed portion of the adhesive joint 150 on one side of the first intumescent layer 104, which can be used to attach the two-ply intumescent joint seal 100 to another object, such as the frame assembly 240 of a wall assembly 230. The exposed portion of the adhesive joint 150 can be covered by a liner or release layer 170 until the two-ply intumescent joint seal 100 is ready for use.

In some configurations, the width 120 of the first intumescent layer 104 can be between about 1/2 to about 7/8 or between about 2/3 to about 3/4 of the width 140 of the second intumescent layer 106. In some configurations, the width 120 of the first intumescent layer 104 can be at least about 2/3 of the width 140 of the second intumescent layer 106, or at least about 3/4 of the width 140 of the second intumescent layer 106.

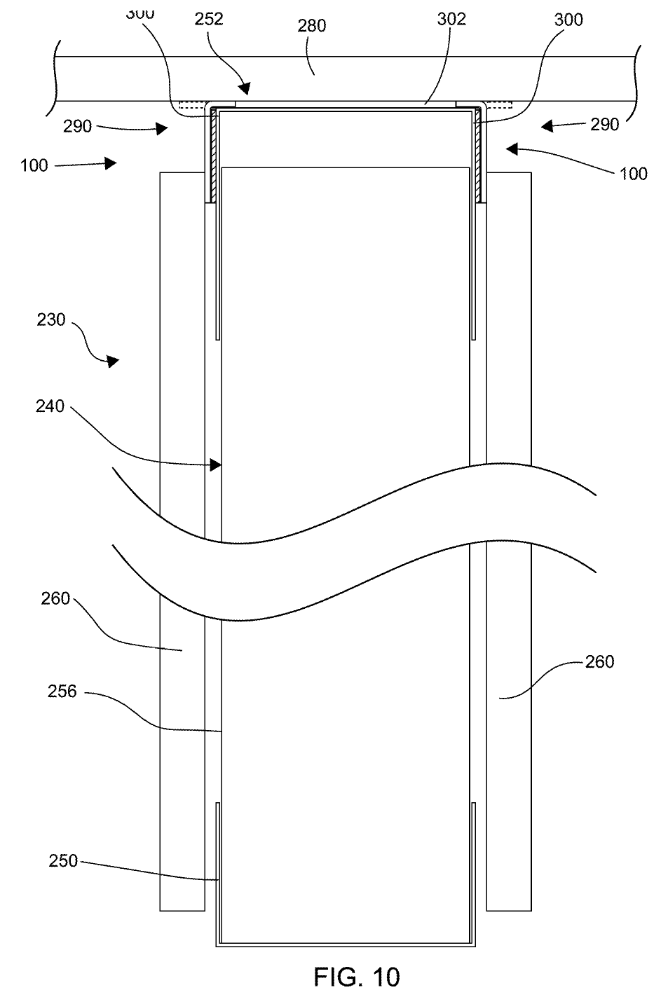

FIG. 10 illustrates a pair of the two-ply intumescent joint seals 100 of FIG. 9 assembled into a wall assembly 230 in a manner similar to or the same as the wall assemblies 230 described previously. In particular, the two-ply intumescent joint seal 100 of FIG. 9 is assembled to a wall assembly 230 in a similar manner as the two-ply intumescent joint seals 100 in the wall assembly 230 of FIG. 8. In particular, one of the two-ply intumescent joint seals 100 is provided in the deflection gap 290 on each side of the wall assembly 230. The two-ply intumescent joint seal 100 is positioned between the header track 252 and the wallboard 270. However, unlike the arrangement of FIG. 8, the two-ply intumescent joint seal 100 is not attached to a flange 300 of the header track 252. Similar to the arrangement of FIG. 8, an upper end of the two-ply intumescent joint seal 100 is attached to either the web 302 of the header track 252 (shown in solid line) or the ceiling 280 (shown in dashed line). Such an arrangement allows the two-ply intumescent joint seal 100 to be installed to the header track 252 prior to attachment of the header track 252 to the ceiling 280 or to be installed after the header track 252 has been attached to the ceiling 280. The wallboard 270 retains the two-ply intumescent joint seal 100 in place against or along the flange 300 despite the two-ply intumescent joint seal 100 not being directly attached to the flange 300. As discussed previously, the two-ply intumescent joint seal 100 can also be used to protect other construction joints, such as the joint at the bottom of the wall assembly 230, a joint between the wall assembly 230 and another structure, or a joint in an intermediate location within a wall assembly 230.

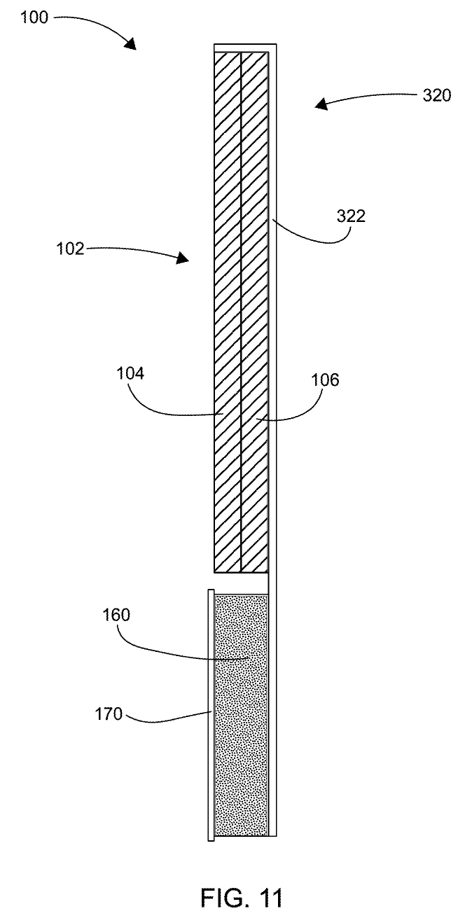

FIG. 11 illustrates two-ply intumescent joint seal 100 that includes a two-ply intumescent strip 102 attached to a support, profile or carrier 320. The carrier 320 includes a portion or a leg 322 that extends along the second side surface 132 of the second intumescent layer 106. In the illustrated arrangement, the leg 322 covers an entirety or a substantial entirety of the second side surface 132. The leg 322 includes a portion that extends below a lowermost extent of the two-ply intumescent strip 102. Accordingly, an overall width of the two-ply intumescent joint seal 100 is greater than the width 186 of the two-ply intumescent strip 102 and, therefore, is greater than the width 120 of the first intumescent layer 104 and the width 140 of the second intumescent layer 106.

In the illustrated arrangement, an upper end of the leg 322 includes a return flange that extends at least partially over the second intumescent layer 106 or the second intumescent layer 106 and the first intumescent layer 104 of the two-ply intumescent strip 102. The return flange can be positioned against the ceiling 280, or another adjacent structure, in use. The two-ply intumescent joint seal 100 could also include a structure or feature that facilitates the creation of a seal with the ceiling 280 or an adjacent structure, which can be a hollow gasket 330 that is the same as or similar to the hollow gasket 330 of the two-ply intumescent joint seal 100 of FIG. 5.

In the illustrated arrangement, the lower portion of the leg 322 below the two-ply intumescent strip 102 includes an adhesive connector 160 that is configured to allow the two-ply intumescent joint seal 100 to be attached to another object, such as a portion of a wall assembly 230. In the illustrated embodiment, the adhesive connector 160 can be a double-sided foam tape. The double-sided foam tape 160 can have a thickness that is the same as or similar to the thickness 196 of the two-ply intumescent strip 102. With such an arrangement, the leg 322 can be planar. However, in other arrangements, the adhesive connector 160 can be thinner than the thickness 196 of the two-ply intumescent strip 102. In such arrangements, the lower portion of the leg 322 can be offset from the upper portion to properly position the adhesive connector 160. A liner or release layer 170 can cover the adhesive connector 160 until the two-ply intumescent joint seal 100 is ready for use. In addition or in the alternative, the two-ply intumescent strip 102 (e.g., the first intumescent layer 104) can include an adhesive connector 160 (and liner or release layer 170).

In the illustrated arrangement, the width 120 of the first intumescent layer 104 is the same as or substantially the same as the width 140 of the second intumescent layer 106. In other arrangements, however, the width 120 of the first intumescent layer 104 can be different from the width 140 of the second intumescent layer 106. In the illustrated arrangement, the thickness 122 of the first intumescent layer 104 is the same as or substantially the same as the thickness 142 of the second intumescent layer 106. However, in other arrangements, the thickness 122 of the first intumescent layer 104 can be different from (e.g., larger than or smaller than) the thickness 142 of the second intumescent layer 106.

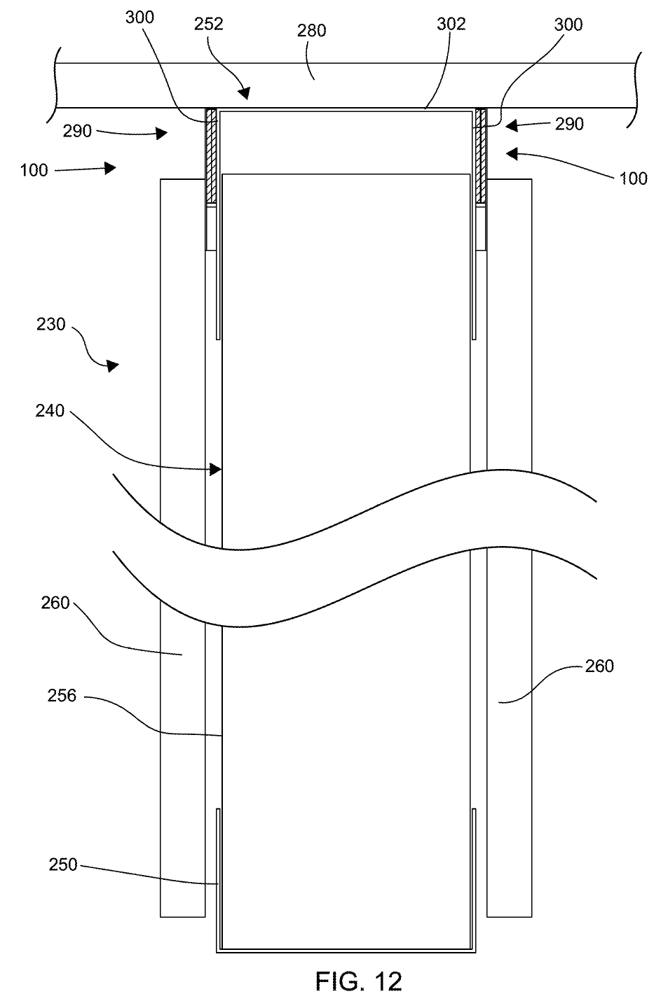

FIG. 12 illustrates a pair of the two-ply intumescent joint seals 100 of FIG. 11 assembled into a wall assembly 230 in a manner similar to or the same as the wall assembly 230 described in connection with FIG. 3. In particular, one of the two-ply intumescent joint seal 100 is provided in the deflection gap 290 on each side of the wall assembly 230. Each two-ply intumescent joint seal 100 is attached to a flange 300 of the header track 252 and is positioned between the header track 252 and the wallboard 270. An upper end of the two-ply intumescent joint seal 100 is positioned adjacent the ceiling 280. However, the two-ply intumescent joint seal 100 can also be used to protect other construction joints, such as the joint at the bottom of the wall assembly 230, a joint between the wall assembly 230 and another structure, or a joint in an intermediate location within a wall assembly 230.

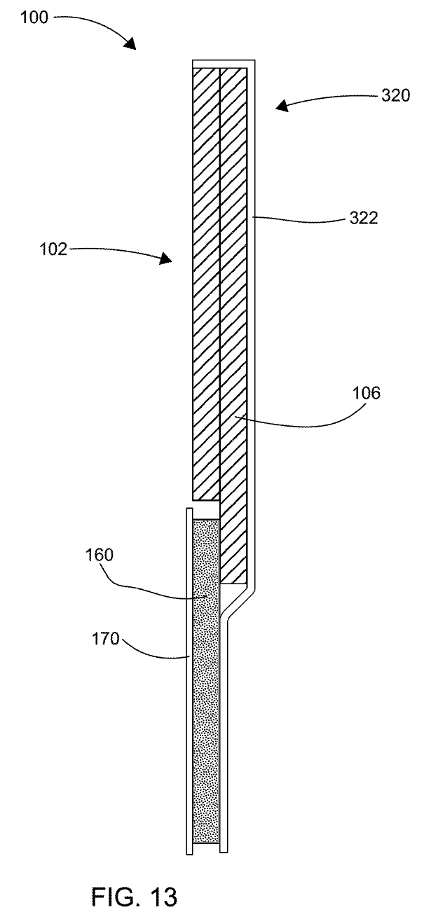

FIG. 13 illustrates two-ply intumescent joint seal 100 that includes a two-ply intumescent strip 102 attached to a support, profile or carrier 320. The carrier 320 includes a portion or a leg 322 that extends along the second side surface 132 of the second intumescent layer 106. In the illustrated arrangement, the leg 322 covers an entirety or a substantial entirety of the second side surface 132. The leg 322 includes a portion that extends below a lowermost extent of the two-ply intumescent strip 102. Accordingly, an overall width of the two-ply intumescent joint seal 100 is greater than the width 186 of the two-ply intumescent strip 102 and, therefore, is greater than the width 120 of the first intumescent layer 104 and the width 140 of the second intumescent layer 106.

In the illustrated arrangement, an upper end of the leg 322 includes a return flange that extends at least partially over the second intumescent layer 106 or the second intumescent layer 106 and the first intumescent layer 104 of the two-ply intumescent strip 102. The return flange can be positioned against the ceiling 280, or another adjacent structure, in use. The two-ply intumescent joint seal 100 could also include a structure or feature that facilitates the creation of a seal with the ceiling 280 or an adjacent structure, which can be a hollow gasket 330 that is the same as or similar to the hollow gasket 330 of the two-ply intumescent joint seal 100 of FIG. 5.

In the illustrated arrangement, the lower portion of the first leg 322 below the two-ply intumescent strip 102 includes an adhesive connector 160 that is configured to allow the two-ply intumescent joint seal 100 to be attached to another object, such as a portion of a wall assembly 230. In the illustrated embodiment, the adhesive connector 160 can be a double-sided foam tape. The double-sided foam tape 160 can have a thickness that is the same as or similar to the thickness 196 of the first intumescent layer 104. With such an arrangement, the leg 322 can be non-planar, with the lower portion of the leg 322 below the two-ply intumescent strip 102 offset from the upper portion of the leg 322 that is aligned with the two-ply intumescent strip 102 to properly position the adhesive connector 160. A liner or release layer 170 can cover the adhesive connector 160 until the two-ply intumescent joint seal 100 is ready for use. In addition or in the alternative, the two-ply intumescent strip 102 (e.g., the first intumescent layer 104) can include an adhesive connector 160 (and liner or release layer 170).

In the illustrated arrangement, the width 120 of the first intumescent layer 104 is the same as or substantially the same as the width 140 of the second intumescent layer 106. In other arrangements, however, the width 120 of the first intumescent layer 104 can be different from the width 140 of the second intumescent layer 106. In the illustrated arrangement, the thickness 122 of the first intumescent layer 104 is the same as or substantially the same as the thickness 142 of the second intumescent layer 106. However, in other arrangements, the thickness 122 of the first intumescent layer 104 can be different from (e.g., larger than or smaller than) the thickness 142 of the second intumescent layer 106.

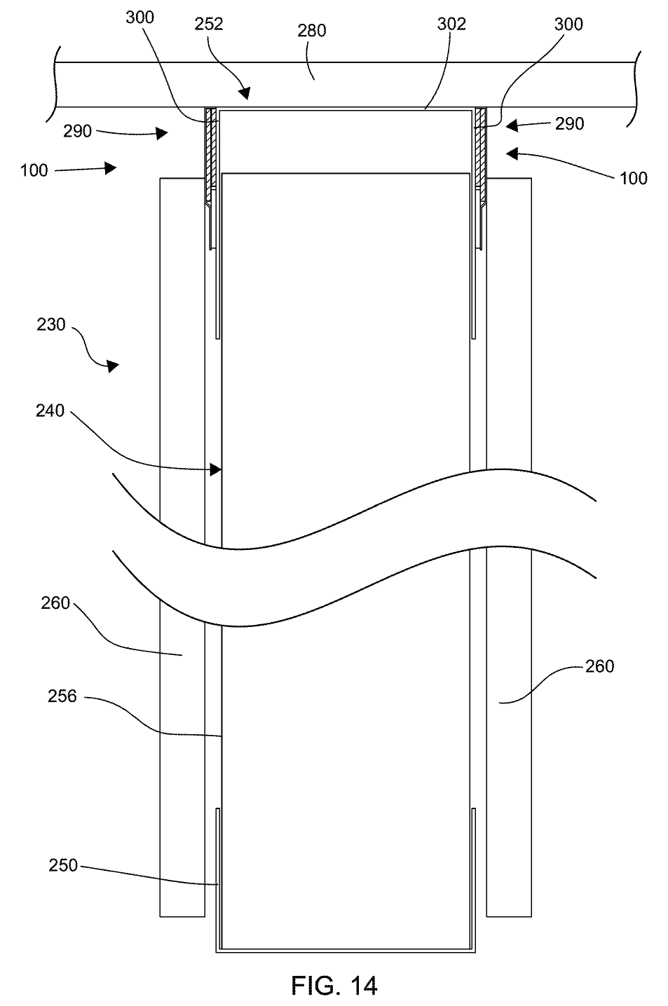

FIG. 14 illustrates a pair of the two-ply intumescent joint seals 100 of FIG. 13 assembled into a wall assembly 230 in a manner similar to or the same as the wall assembly 230 described in connection with FIG. 3. In particular, one of the two-ply intumescent joint seal 100 is provided in the deflection gap 290 on each side of the wall assembly 230. Each two-ply intumescent joint seal 100 is attached to a flange 300 of the header track 252 and is positioned between the header track 252 and the wallboard 270. An upper end of the two-ply intumescent joint seal 100 is positioned adjacent the ceiling 280. However, the two-ply intumescent joint seal 100 can also be used to protect other construction joints, such as the joint at the bottom of the wall assembly 230, a joint between the wall assembly 230 and another structure, or a joint in an intermediate location within a wall assembly 230.

It should be noted that the possible two-ply intumescent joint seal 100 are not limited to the above-described examples. Features of any one of the several examples can be implemented on others of the examples. For example, the adhesive connector 160 that is shown or described to be a double-sided film tape can be replaced with a double-sided foam tape, and vice-versa, or can be replaced with another suitable adhesive. Furthermore, any of the carriers 320 can include or omit the hollow gasket 330. Any of the two-ply intumescent joint seal 100 can include a carrier 320 that includes or omits the hollow gasket 330. Any of the two-ply intumescent strips 102 can be replaced with a strip having more than two plies or layers of intumescent material. The first intumescent layer 104 and the second intumescent layer 106 can be of the same or a different width or thickness. Any combination of features from the various example two-ply intumescent joint seals 100 can be combined to create a two-ply intumescent joint seal 100 and is intended to be covered within the scope of this application. Moreover, an aspect of the present disclosure involves the methods of manufacturing a two-ply intumescent joint seal 100 having a two-ply intumescent strip 102 that is configured to provide for sequential activation of the first intumescent layer 104 and the second intumescent layer 106, as described herein, or the methods of assembling a wall assembly (or other structure) including such a two-ply intumescent joint seal 100 to protect a construction joint.

### CONCLUSION

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3, and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

What is claimed is:

1. A fire-rated wall joint seal, comprising:
a first intumescent layer and a second intumescent layer attached to one another;
wherein the first intumescent layer is configured to expand at a lower temperature or at an earlier stage of fire exposure than the second intumescent layer;
wherein the expansion of the first intumescent layer displaces the second intumescent layer away from a heat source and forms a thermally insulating barrier that delays expansion and degradation of the second intumescent layer.

2. The fire-rated wall joint seal of claim 1, wherein the first intumescent layer is configured to function as a sacrificial layer that undergoes substantial expansion and structural degradation prior to expansion of the second intumescent layer.

3. The fire-rated wall joint seal of claim 2, wherein expansion of the first intumescent layer increases the distance between the second intumescent layer and the heat source during fire exposure.

4. The fire-rated wall joint seal of claim 2, wherein the sacrificial expansion of the first intumescent layer reduces heat transfer to the second intumescent layer.

5. The fire-rated wall joint seal of claim 1, wherein the first intumescent layer forms an expanded char layer that acts as a thermal barrier protecting the second intumescent layer.

6. The fire-rated wall joint seal of claim 1, wherein the second intumescent layer maintains structural integrity for a longer duration than the first intumescent layer during fire exposure.

7. The fire-rated wall joint seal of claim 1, wherein the second intumescent layer limits the passage of hot gases through the joint after expansion of the first intumescent layer.

8. The fire-rated wall joint seal of claim 1, wherein the first intumescent layer and the second intumescent layer are configured to expand sequentially rather than simultaneously.

9. The fire-rated wall joint seal of claim 8, wherein the first intumescent layer reaches maximum expansion prior to initiation of expansion of the second intumescent layer.

10. A fire-rated wall joint seal, comprising:
a first intumescent layer having a length, a first side surface extending along the length, a second side surface extending along the length, and a thickness defined between the first side surface and the second side surface of the first intumescent layer; and
a second intumescent layer having a length, a first side surface extending along the length, a second side surface extending along the length, and a thickness defined between the first side surface and the second side surface of the second intumescent layer;
wherein the first intumescent layer and the second intumescent layer are formed separately and are attached to one another along their respective first side surfaces by an adhesive joint.

11. The fire-rated wall joint seal of claim 10, wherein a combined thickness of the first intumescent layer and the second intumescent layer is equal to or greater than 95 percent of a total thickness of the fire-rated wall joint seal.

12. The fire-rated wall joint seal of claim 10, wherein a combined thickness of the first intumescent layer and the second intumescent layer is equal to or greater than 98 percent of a total thickness of the fire-rated wall joint seal.

13. The fire-rated wall joint seal of claim 10, wherein a combined thickness of the first intumescent layer and the second intumescent layer is equal to or less than 6 mm.

14. The fire-rated wall joint seal of claim 10, wherein the thickness of the first intumescent layer is equal to or substantially equal to the thickness of the second intumescent layer.

15. The fire-rated wall joint seal of claim 10, wherein a width of the fire-rated wall joint seal is between 1/2 inch and 6 inches.

16. The fire-rated wall joint seal of claim 10, wherein a width of the first intumescent layer and a width of the second intumescent layer are substantially equal.

17. The fire-rated wall joint seal of claim 10, wherein a width of the first intumescent layer is less than a width of the second intumescent layer.

18. The fire-rated wall joint seal of claim 10, further comprising an adhesive layer extending along a portion or an entirety of the second side surface of one of the first intumescent layer and the second intumescent layer.

19. The fire-rated wall joint seal of claim 10, wherein the first intumescent layer and the second intumescent layer form a multi-layer intumescent strip, which is attached to a support layer.

20. The fire-rated wall joint seal of claim 10 assembled within a joint of a wall assembly having a frame comprising a header track, a footer track, and a plurality of studs, the wall assembly further comprising at least one wallboard attached to the plurality of studs on one or both sides of the wall assembly.

21. The wall assembly of claim 20, wherein the fire-rated wall joint seal is positioned between the frame and the at least one wallboard.
